(19) United States
(12) Patent Application Publication
(10) Pub. No.: US 2026/0273745 A1
(43) Pub. Date: Sep. 17, 2026

(54) SYSTEM AND METHOD OF PROVIDING CASE PICKING AUTOMATION WITH HUMAN AND ROBOT ORCHESTRATION

(71) Applicant: Vecna Robotics, Inc., Waltham, MA (US)

(72) Inventors: Qing Li, Medford, MA (US); Joshua Ornstein, Lexington, MA (US)

(21) Appl. No.: 19/079,920

(22) Filed: Mar. 14, 2025

(51) Int. Cl. B25J 9/16

(52) U.S. Cl. CPC B25J 9/1666

(57) ABSTRACT

A device may include an orchestration system, a robot in communication with the orchestration system and a mobile device in communication with the orchestration system. The device can be configured to: receive an order that requires case picking, dispatch the robot to navigate autonomously to a pick location, transmit an instruction to the mobile device to direct a human to the pick location and to perform a pick task by moving items to the robot at the pick location, log a completed pick report from the mobile device of the human when the pick task at the pick location to the robot is complete; and continuously monitor the robot and the mobile device to make dynamic adjustments for one or more of the robot or the human for pick tasks.

### FIELD OF THE INVENTION

The present technology pertains to robotics and more specifically to a system and method of providing a case picking automation approach in which both human and robot movement to pick locations are orchestrated, monitored and optimized to reduce travel time, increase productivity, enhance safety and provide real-time analytical insights.

### BACKGROUND

Currently, in warehouses where goods are moved around, warehouse picking operations are typically manual. There are significant inefficiencies, risks, and complexities in traditional case-picking workflows. In many warehouses, workers spend a disproportionate amount of time traveling between pick locations, often riding on forklifts or electric pallet jacks (EPJs), which is not only time-consuming but also one of the most dangerous aspects of the job. The movement of humans in this manner leaves less time for actual picking activities and increases the likelihood of workplace injuries. Combined with challenges like coordinating multi-stop orders, maintaining inventory accuracy, and minimizing errors, these issues slow fulfillment, drive up labor costs, and compromise productivity, particularly in high-demand operations.

### SUMMARY

What is needed in the art is an new mode of operation in which an orchestration system manages movement of both robots and humans. The new system orchestrates collaboration between robots and human associates. The disclosed approach is an advanced automation solution designed to revolutionize case-picking operations in warehouses by combining powerful orchestration software with robots which can be autonomous mobile robots (AMRs). The system removes the most time-consuming and dangerous aspects of manual case picking, which is driving forklifts and EPJs and thus allows human associates to focus on high-value tasks like picking. By leveraging AMRs to transport pallets autonomously, the system increases safety, reduces training time, and boosts productivity. Humans can utilize mobile devices such as, for example, wearables on their hand with an intuitive wearable interface. The mobile device can enhance user experience and retention, while real-time actionable data and historical analytics drive continuous improvement through the use of a console which can be a web dashboard. Additionally, the orchestration system optimizes robot paths, reduces congestion, minimizes associate idle time, and dynamically allocates work to maximize efficiency, all monitored through a 24/7 remote command system or command center that resolves operational issues rapidly. The orchestrated management of movements of both humans and robots can be characterized as a “case flow” and a system that orchestrates, monitors, manages and so forth these processes can be called in some cases a case flow system.

In some aspects, the techniques described herein relate to a system including: an orchestration system including at least one processor and a computer-readable storage device that stores instructions; a robot in communication with the orchestration system; and a mobile device in communication with the orchestration system, wherein the instructions cause the at least one processor of the orchestration system to be configured to: receive an order that requires case picking; dispatch the robot to navigate autonomously to a pick location; transmit an instruction to the mobile device to direct a human to the pick location and to perform a pick task by moving items to the robot at the pick location; log a completed pick report from the mobile device of the human when the pick task at the pick location to the robot is complete; and continuously monitor the robot and the mobile device to make dynamic adjustments for one or more of the robot or the human for pick tasks.

In some aspects, the techniques described herein relate to a method including: receiving, at an orchestration system, an order that requires case picking; dispatching, from the orchestration system, a robot to navigate autonomously to a pick location; transmitting an instruction to a mobile device to direct a human to the pick location and to perform a pick task by moving items to the robot at the pick location; logging a completed pick report from the mobile device of the human when the pick task at the pick location to the robot is complete; and monitoring the robot and mobile device to make dynamic adjustments for one or more of the robot or the human for pick tasks.

In some aspects, the techniques described herein relate to a system including: an orchestration system including at least one processor and a computer-readable storage device that stores instructions; a robot in communication with the orchestration system; a command system in communication with the orchestration system; and a mobile device in communication with the orchestration system, wherein the instructions cause the at least one processor of the orchestration system to be configured to: receive an order that requires case picking; dispatch the robot to navigate autonomously to a pick location; transmit an instruction to the mobile device to direct a human to the pick location and to perform a pick task by moving items to the robot at the pick location; log a completed pick report from the mobile device of the human when the pick task at the pick location to the robot is complete; and continuously monitor, via the command system, the robot and mobile device to make dynamic adjustments for one or more of the robot or the human for pick tasks.

In some aspects, the techniques described herein relate to a method including: receiving, from a warehouse management system, at an orchestration system and via an application programming interface configured for communicating data between the orchestration system and the warehouse management system, a demand that requires case picking; dispatching, from the orchestration system and based on the demand, a robot to navigate autonomously to a pick location; transmitting an instruction to a mobile device to direct a human to the pick location and to perform a pick task by moving items to the robot at the pick location; and transmitting status messages via message queuing when an event occurs on a status of the demand. The method can further include transmitting pick exceptions to a warehouse management system, and receiving instructions on how to handle the exception. In some aspects, the techniques described herein relate to an orchestration system including: at least one processor; and a computer-readable storage device that stores instructions which, when executed by the at least one processor, cause the at least one processor to be configured to: receive, from a warehouse management system and via an application programming interface configured for communicating data between the orchestration system and the warehouse management system, a demand that requires case picking; dispatch, based on the demand, a robot to navigate autonomously to a pick location; transmit an instruction to a mobile device to direct a human to the pick location and to perform a pick task by moving items to the robot at the pick location; and transmit status messages via message queuing when an event occurs on a status of the demand.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates a case flow system, according to some aspects of this disclosure;

FIG. 1B illustrates another view of the case flow system, according to some aspects of this disclosure;

FIG. 2 illustrates a warehouse view of the case flow system, according to some aspects of this disclosure;

FIG. 3 illustrates a method embodiment, according to some aspects of this disclosure;

FIG. 4A illustrates another method embodiment, according to some aspects of this disclosure;

FIG. 4B illustrates yet another method embodiment, according to some aspects of this disclosure; and

FIG. 5 illustrates a computing device, according to some aspects of this disclosure.

### DESCRIPTION OF EXAMPLE EMBODIMENTS

Various example embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment and such references mean at least one of the example embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative example embodiments mutually exclusive of other example embodiments. Moreover, various features are described which may be exhibited by some example embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various example embodiments given in this specification.

Without intent to limit the scope of the disclosure, examples of instruments, apparatus, methods and their related results according to the example embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

For clarity of explanation, in some instances the present technology may be presented as including individual functional blocks including functional blocks comprising devices, device components, steps or routines in a method embodied in software, or combinations of hardware and software.

The following discussion introduces a case flow system, such as in a warehouse, that intelligently manages movement of both robots and humans to specific pick locations for loading for example, a pallet jack with items at each location. The case flow system can include one or more of a computer system, communication components, wearable devices for humans or mobile devices that can be carried around to get instructions, manage input, report status and so forth. Robots can be part of the case flow system in which respective robots are in communication with the computing device and/or mobile devices or wearable devices to move to pick locations to have humans load up the robot with products, cases, boxes and so forth. In some aspects, the robots do not communicate directly with the mobile devices or wearable devices. Robot communication may be through a central server/orchestration system.

The case flow system addresses the significant inefficiencies, risks, and complexities in traditional case-picking workflows. In many warehouses, workers spend a disproportionate amount of time traveling between pick locations, often riding on forklifts or electric pallet jacks (EPJs), which is not only time-consuming but also one of the most dangerous aspects of the job. The traditional arrangement leaves less time for actual picking activities and increases the likelihood of workplace injuries. Combined with challenges like coordinating multi-stop orders, maintaining inventory accuracy, and minimizing errors, these issues slow fulfillment, drive up labor costs, and compromise productivity, particularly in high-demand operations.

The general approach is known to use Autonomous Mobile Robots (AMRs) to autonomously transport containers (e.g., totes, cartons) for a picklist and decoupling associates from processing discrete pick lists one at a time. While AMRs have been introduced in piece picking operations, they lack any sophistication or efficiency that is made possible through the concepts disclosed herein.

The new approach disclosed herein improves upon previous systems by providing improved payload capacity and safety. Case picking involves handling significantly larger volumes (up to 60 cu ft) and heavier payloads (up to 3,000 lbs) compared to piece picking, which rarely exceeds 100 lbs. Consequently, AMRs used in case picking require much higher payload capacity and stricter safety compliance. The disclosed AMRs address this need with a robust three-level safety system, including a fully-isolated ISO 13849-1 Category-3 Performance Level D safety system, ensuring compliance and safety in demanding environments.

The proposed system improves upon ergonomics for human associates. Case picking requires associates to lift larger, heavier items, making ergonomics a critical factor. Unlike systems relying primarily on robot-mounted tablets for interactions, the disclosed system employs lightweight, compact wearable devices (generally any mobile device) to provide instructions and facilitate scanning. This approach minimizes physical strain and improves the user experience for associates.

Further, the disclosed system provides for improved orchestration and optimization. Case picking facilities typically feature larger footprints and lower pick densities than piece-picking facilities. In such environments, the disclosed orchestration system plays a pivotal role in intelligently directing associates to nearby robots to minimize travel and search time. It also optimizes overall system performance by dynamically allocating tasks based on proximity, workload balancing, and system conditions.

The improvements discussed above highlight the disclosed system's specialization for the unique challenges of case picking. The differentiation underlines the innovative application of AMRs and orchestration to enhance safety, ergonomics, and efficiency in the specific domain. The principles however can also apply to broader piece picking domains as well.

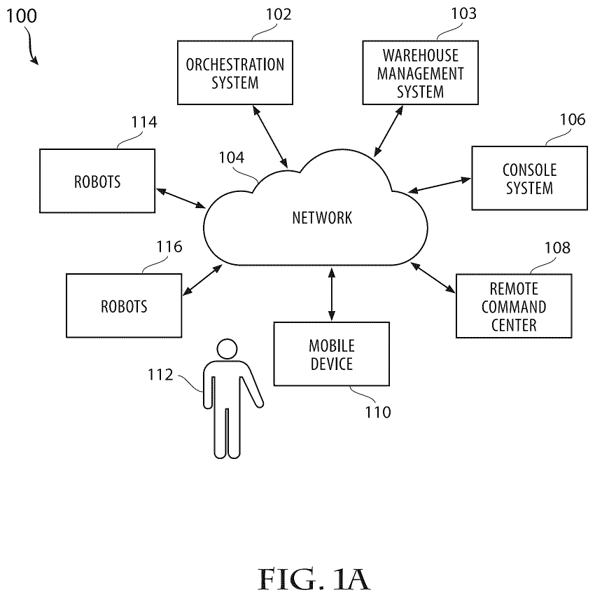

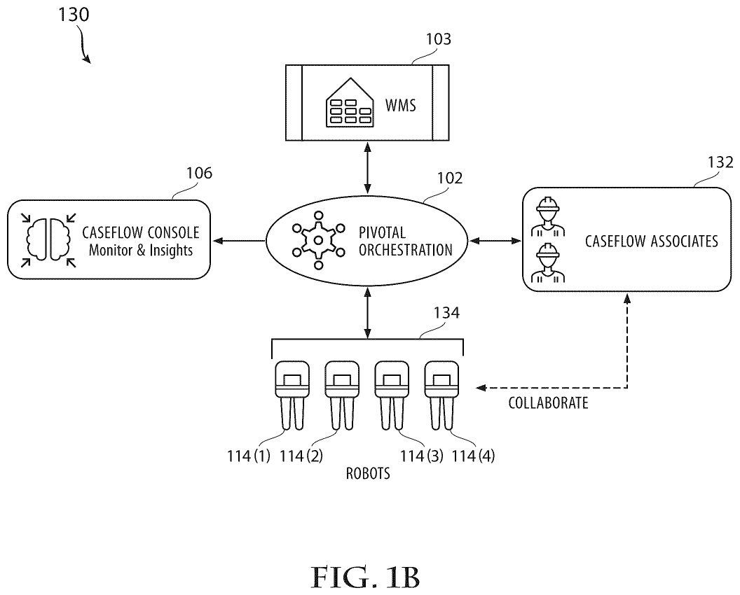

FIG. 1A illustrates a case flow system 100 (or just “system”) including a number of components. An orchestration system 102 includes intelligent software connected via a network 104 to a warehouse management system 104 or a remote command center 108. The remote command center 108 can refer to a remote command center where operators monitor system and robot performance continuously and are able to resolve edge cases remotely. The orchestration system 102 may not directly be connected to the remote command center 108. The remote command center 108 can be connected to a server, which encompass the orchestration system 102 but also can include other components, for monitoring and teleoperation. The orchestration system 102 can connect to the robots and a mobile device 110 which can be an associate wearable interface for communicating tasks and status. Externally, the orchestration system 102 can connect to the warehouse management system 103 for receiving orders and reporting status.

A warehouse management system 103 can provide orders to the orchestration system 102 to prepare for assignments to get the orders fulfilled. The orchestration system 102 directs pickers, such as human 112, and the first robot 114 and/or the second robot 116 together to specific pick locations at specific times in real-time workflow optimization. The human 112 has a mobile device 110 which can be a wearable such as an electronic device configured to be strapped to the human's hand or wrist or can be a handheld device. The robots 112 can be an automated electric pallet-lack, tugs or other AMRs that can transport a pallet or tow cart(s) for loading cases of goods. The first robot 114 and the second robot 116 can autonomously navigate through an optimized pick path, reducing overall travel for human associates. The mobile device 110 can receive assignments from the orchestration system 102 via the network 104. The assignments are for the human 112 to be assigned a zone or schedule with tasks to pick to specific robots. For example, the human 112 may be told to be at a specific pick location in isle four in three minutes and pick and stack a set of boxes on the pallet of a specific robot which will be at that pick location.

A console system 106 provides real-time telemetry and performance data and a set of historical data analytics for continuous improvement. A command system 108 can act as a command center with remote monitoring and intervention capabilities as required. The command system 108 keeps the goods flowing and can override instructions from the orchestration system 102 when necessary. Each of these components is connected via a network 104 and one or more of the components can include an artificial intelligence model that can be trained on case flow historical data and can be used to make real-time decisions regarding routing, flow optimization, pick locations, pick timing, movements of the human 112, movement of the first robot 114 and the second robot 116, and so forth.

In one example, the orchestration system 102 can include an artificial intelligence model or some other software model which can maintain current knowledge of current assignments for the human 112 and the first robot 114 and the second robot 116 (as well as multiple human assignments for moving through a warehouse to picking locations) and the orchestration system 102 can receive a new order and propose an assignment to direct one or more humans and the first robot 114 and the second robot 116 to various pick locations at specific times with instructions for picking and loading cases on to the first robot 114 and the second robot 116. The software model can determine whether the proposed package of assignments is most efficient and can propose amendments or revisions to the package of assignments before they are selected and started on the mobile device 110.

The case flow system 100 solves the issues raised above by leveraging advanced automation and orchestration to streamline case-picking workflows. The first robot 114 and the second robot 116 (which can be AMRs or electronic pallet jacks (EPJs)) handle pallet movement, eliminating the most time-consuming and dangerous aspect of manual case picking, which is traveling with forklifts or EPJs. The mobile device 110 can include a user-friendly interface that provides instructions to direct the human 112 to collaborate with different AMRs and guides them through intuitive picking workflows, ensuring accuracy and efficiency. The orchestration system 102 coordinates seamless collaboration between AMRs and human associates, while real-time data insights and historical analytics provide actionable information to optimize operations. Additionally, the command system 108 can operate twenty-four hours a day, seven days a week to resolve a majority of edge cases swiftly, minimizing downtime and reducing the need for on-site intervention.

FIG. 1B illustrates an alternative view of the case flow system 100 which can be called a pivotal orchestration system 130. The orchestration system 102 can be called a pivotal orchestration component and can include the warehouse management system 103, a consol system 106 or case flow console, interactions with case flow associates 132 and a set of robots 134 which can include a first robot 114 and a second robot 116 and others as well. The set of robots 134 can refer to co-bot pallet jacks that autonomously navigate through an optimized pick path. The path is chosen, and periodically updated, to reduce overall travel and improve efficiency and safety.

FIG. 1B illustrates the pivotal orchestration system 130 and provides further insight into how the system works. The pivotal orchestration system 130 and its various components when implemented can streamline operations and increase efficiency. The natural result is cost savings and an improved worker experience. The system can provide real-time and actionable data insights and is easily scalable to larger or smaller environments.

The new approach using the pivotal orchestration system 130 can be integrated with existing warehouse management systems such as warehouse management system 103. The system integrations with warehouse management system 103 can be achieved using a standardized application programming interface (API). In some aspects, the warehouse management system 103 sends or transmits work requests (or demands), preferably in larger batches, to pivotal orchestration system 130 and the system sends back status messages when specific events occur to update the warehouse management system 103 on the status of the requests. The API can be configured in various ways. One example protocol is RabbitMQ which can be used for message queuing and the system can support a custom translation layer for data and protocol transformation if the warehouse management system 103 can't integrate directly with RabbitMQ. The architecture can be scalable and safe.

In addition, the warehouse management system 103 can send updates to a demand or cancel a demand. In some aspects, the status events can include one or more of: (1) DEMAND_CREATED—The system successfully created the new demand; (2) DEMAND_REJECTED—The system could not create the new demand; (3) UPDATE_APPLIED—The system applied the updates from the update request; (4) UPDATE_PARTIALLY_APPLIED—The system applied some of the updates from the update request; (5) UPDATE_REJECTED—The system could not apply any of the updates from the update request; (6) PICK_LIST_STARTED—The pick list is now considered to be in progress and the demand can no longer be canceled; (7) PICK_DONE—A pick in the pick list is done; (8) DROPOFF_COMPLETE—The AMR has dropped off the pallet; (9) CANCELLATION_COMPLETE—The system successfully canceled the demand; (10) CANCELLATION_REJECTED—The system could not cancel the demand: (11) DEMAND_FAILED—The AMR could not complete the demand: (12) UNEXPECTED_ERROR—An unexpected error occurred. Other events are contemplated as well and the above list are exemplary only.

The standard API can use RabbitMQ for message queuing and the system can support a custom translation layer for data and protocol transformation. By leveraging RabbitMQ, the system ensures decoupled and asynchronous communication, where the system publishes messages, such as inventory updates or order statuses, to specific queues that the warehouse management system 103. The custom translation layer acts as a mediator, converting data formats from the orchestration system 102 into those expected by the warehouse management system 103, handling protocol differences, and validating and enriching the data before it reaches the warehouse management system 103. To ensure reliability, the system implements retry mechanisms for handling message delivery failures. Additionally, the system is designed for scalability, with RabbitMQ (or a similar protocol) capable of horizontal scaling and the translation layer being stateless, allowing for load balancing and distributed processing. Security is a priority, with RabbitMQ's authentication, authorization, and TLS/SSL encryption safeguarding the communication channels. Monitoring and logging are integral to the disclosed approach, providing visibility into message flows and system performance. The architecture ensures a robust, scalable, and secure integration with the warehouse management system 103, facilitating seamless data exchange and system interoperability.

The disclosed approach allocates tasks between AMRs (such as the set of robots 134) and human workers or case flow associates 132, ensuring optimal productivity. The work allocation for AMRs can be configured as follows. The work allocation can adhere to priority levels set by the warehouse management system 103. An orchestration algorithm operated by the orchestration system 102 can schedule higher priority work before scheduling lower priority work. The system can also support following additional constraints. The orchestration system 102 can balance workload across multiple associate work zones to avoid overloading or underutilization. The system can optimize the trade-off between increasing pick density and minimizing congestion. The system can adjust or manage work allocation for associates. The orchestration system 102 can minimize idle time to maximize productivity. The system can reduce associate travel distance for greater efficiency. The orchestration system 102 can distribute work based on factors like worker fatigue (on-foot travel & weight lifted) and completed tasks allows associates to request tasks from nearby AMRs, enhancing engagement and control

In some aspects, the orchestration system 102 disclosed herein assigns demands to AMRs in various ways. In one example, the orchestration system 102 can operate a pivotal orchestration engine that evaluates a number of factors when allocating work (e.g., the system can choose the next best “WMS demand” to allocate) to each AMR. The various factors considered in this evaluation are as follows. One consideration can be applied if there are any constraints that block the allocation of the demand. One of the common constraints is the capacity check of the initiation spot for the case flow workflow. In order to avoid congestion at the initiation spot, the capacity of the spot can be configured to avoid backing up initiation areas and blocking other areas in the facility with waiting robots. If there are no blocking constraints, priority will be the first deciding factor when choosing the next best demand to allocate. The orchestration system 102 will schedule higher priority work before scheduling lower priority work. A demand can have an integer priority value (positive, negative, or zero) with a default value of zero. Higher numbers in one example can mean higher priority. Priority may not only be used for allocation of the work but also for ordering of the allocated work in an AMR's work queue.

For demands of the same priority, the orchestration system 102 can take in additional factors for selecting which demand to allocate next, like idle zone monitoring. To optimize the flow of cases or products through various zones in a warehouse, the orchestration system 102 can provide advanced configuration capabilities that allow precise customization of zones and aisles. The orchestration system 102 ensures that AMRs are strategically distributed across these zones, aligned with the dynamic demand profile. Idle zone checks play a role in this process by continuously monitoring the utilization of each zone. These checks help to identify any underutilized or idle zones in real time, allowing for immediate adjustments to AMR allocation. The proactive approach ensures that AMRs are optimally positioned which enhances operational efficiency, reduces bottlenecks, and maintains a balanced workflow throughout the warehouse. By leveraging these configuration and monitoring capabilities, the orchestration system 102 can significantly improve the throughput, responsiveness, and overall productivity of warehouse operations.

The orchestration system 102 also assigns interactions to case flow associates 132. The orchestration system 102 considers a number of factors while optimizing associate-AMR interactions which involves considering specific criteria to efficiently allocate tasks and ensure worker productivity. The following factors are considered in determining the priority for associate interactions. The orchestration system 102 seeks to minimize idle time of associates. It is helpful to ensure that associates are engaged in productive tasks and not left waiting or idle. The orchestration system 102 prioritizes interactions to idle workers in order to minimize downtime. The orchestration system 102 seeks to minimize associate travel distance. Reducing the distance associates need to travel to perform tasks is valuable. The orchestration system 102 prioritizes interactions are nearer to the associate's current location to minimize travel time, optimizing overall efficiency.

The orchestration system 102 seeks to allow the associate to choose a robot to service. Providing autonomy to workers to be able to request interactions from a waiting robot in their area can enhance their engagement and efficiency. This factor provides flexibility and potentially increases the effectiveness in completing tasks. The orchestration system 102 also seeks to distribute work based on worker fatigue levels and completed tasks. The orchestration system evaluates worker fatigue based on one or more factors. For example, factors can include the total weight lifted (if case weight data is provided by the warehouse management system, the number of cases picked), the associate's step count, travel distance and other factors as well. The orchestration system 102 can prioritize interactions that distribute workload based on worker fatigue to prevent exhaustion and maintain productivity. Factoring in the interactions completed so far by each worker to balance the workload among workers effectively is built into the orchestration system 102.

In some aspects, the orchestration system 102 can perform real-time monitoring and adjustment. The system continuously monitors operations and makes real-time adjustments to improve efficiency. The orchestration system 102 constantly monitors incoming work requests. For example, if a higher-priority request is received, the system can quickly prioritize and assign it over lower-priority tasks already in the queue. The orchestration system 102 performs dynamic optimization. The system assesses the current state of the system and environment, performing forward simulations to anticipate and mitigate potential future risks, ensuring smooth operations.

The orchestration system 102 performs congestion management. A fleet manager engine or component in the orchestration system 102 can actively monitor congestion in real-time, considering both current and upcoming activities. It can adjust schedules or reroute robots to minimize bottlenecks and maintain efficient operations. The orchestration system 102 can perform worker fatigue monitoring by continuously tracking worker fatigue levels, adjusting task allocation in real-time to balance workloads and sustain team efficiency.

The orchestration system 102 continuously monitors the system, tracking incoming work requests (i.e., demands, batch orders, orders, etc.) and the execution of ongoing tasks. It constantly assesses whether tasks are optimally allocated and can reassign work that hasn't yet started to improve efficiency.

The orchestration system 102 not only assesses the current state of the system and environment but also performs forward simulations to anticipate and mitigate potential future risks. This proactive approach ensures that decisions made now won't negatively impact operations later. The orchestration system 102 performs data-driven decision-making. For example, the orchestration system 102 obtains live metric data for real-time monitoring. The data that is obtained can include a live floor map that displays real-time locations of AMRs and associates, offering a clear view of floor activities for better decision-making. The orchestration system 102 can include live metric data that provides real-time monitoring to keep track of shift progress and operational performance and quickly address any issues. The orchestration system 102 can track associate performance metrics and track real-time associate performance to boost engagement and ensure balanced workloads.

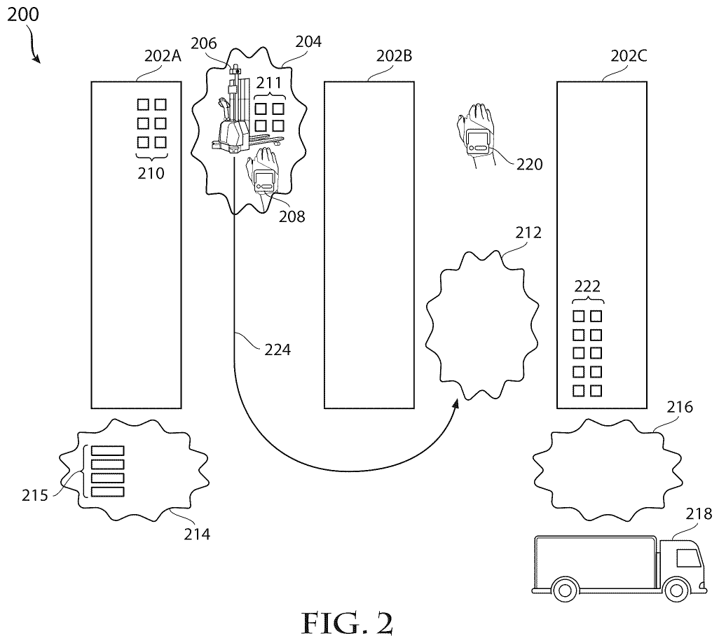

FIG. 2 illustrates a warehouse 200 which can include a first set of shelves 202A, a second set of shelves 202B and a third set of shelves 202C. The first set of shelves 202A stores a set of boxes 210. The set of boxes 210 can represent any items that need to be “picked” or moved onto the robot for further processing.

The case flow system 100 optimizes case-picking workflows by combining the first robot 114 and the second robot 116 such as autonomous mobile robots (AMRs), an associate wearable interface configured on the mobile device 110, and advanced orchestration software operating on the orchestration system 102. At the start of each shift, the warehouse management system 103 sends an order (i.e., a batch order or a demand or pick list) to the orchestration system 102. The orchestration system 102 organizes and optimizes order schedules, assigns tasks across the fleet, and dispatches the first robot 114 and the second robot 116 (i.e., AMRs) to an initiation area 214. The initiation area 214 can include a set of empty pallets 215 for use by the first robot 114 and the second robot 116. After being loaded with empty pallets, the first robot 114 and the second robot 116 autonomously navigate optimized paths to pick locations such as a first pick location 204. In this example, a robot 206 is tasked with moving to the first pick location 204.

The human 112 logs in to the mobile device 110 (i.e., such as a wearable device 208), which direct them to their first pick location 204. There, the human 112 scans the robot 206 to access the pick list and the human 112 is guided through the workflow. The set of cases 211 can represent the completed task of loading the cases onto the robot 206. Completed picks are logged by the human 112 on the wearable device 208, and the human releases the robot 206 to autonomously travel to its next stop via a robot path 224, which can be a second pick location 212, where a second set of cases 222 can be positioned for loading onto the robot 206. A second mobile device 220 may be associated with a second human who can be directed to the second pick location 212 for loading the second set of cases 222. The human 112 with the wearable device 208 can be directed to another task. When an order pallet is complete, the robot 206 autonomously drops it at a staging area 216. The initiation area 214 can include maintenance capabilities such as allowing for battery checks and hot swaps before continuing the cycle. An application operating on the mobile device 110 or the wearable device 208 enables the human 112 to log exceptions, track progress, and manage breaks. A vehicle 218 can be positioned near the staging area 216 for taking the items to their destination. Through the command system 108, operation managers can monitor system performance and progress via a real-time console such as the console system 106.

Throughout the process, the orchestration system 102 continuously monitors the system, manages congestion, dynamically allocates work to minimize idle time and associate travel, and seeks optimization opportunities.

At the end of the shift, the human 112 logs out of the mobile device 110, and the first robot 114 and the second robot 116 complete their final tasks before returning to a home area or charge area. The final tasks, for example, can be drop off tasks or other types of tasks. The fully integrated system improves safety, reduces travel and idle time, and enhances operational efficiency.

The case flow system 100 is an advanced automation solution designed to revolutionize case-picking operations in warehouses by combining powerful orchestration software with the first robot 114 and the second robot 116 such as AMRs. The case flow system 100 removes the most time-consuming and dangerous aspects of manual case picking, which include driving forklifts and EPJs and allows human associates to focus on high-value tasks like picking. By leveraging the first robot 114 and the second robot 116 to transport pallets autonomously, the disclosed approach increases safety, reduces training time, and boosts productivity. Its intuitive wearable interface on the mobile device 110 for a human 112 enhances user experience and retention, while real-time actionable data and historical analytics drive continuous improvement. Additionally, the orchestration system 102 optimizes robot paths, reduces congestion, minimizes associate idle time, and dynamically allocates work to maximize efficiency, all monitored through a full-time remote command center (i.e., the command system 108) that resolves operational issues rapidly.

The case flow system 100 automates pallet transport with the first robot 114 and the second robot 116 and eliminates the most time-consuming and hazardous travel tasks. In this approach, the case flow system 100 increases associate productivity. The case flow system 100 frees associates to focus on the highest-value task, picking, and allows associates to collaborate with multiple robots, decoupling associates from processing one pick list at a time.

The case flow system 100 reduces the need for associates to operate forklifts or EPJs manually, thus minimizing workplace safety incidents. The case flow system 100 provides real-time and analytical insights. The consol system 106 offers real-time actionable data and historical analytics for continuous improvement and informed decision-making.

The use of the case flow system 100 can shorten training time. Associates no longer need training to drive forklifts or memorize travel rules, and the system's intuitive, user-friendly interfaces simplify onboarding, enabling faster ramp-up for new workers. In the end, the case flow system 100 improves the user experience and worker retention. Streamlined and engaging workflows and reduced cognitive loads create a better work environment, increasing satisfaction and retention.

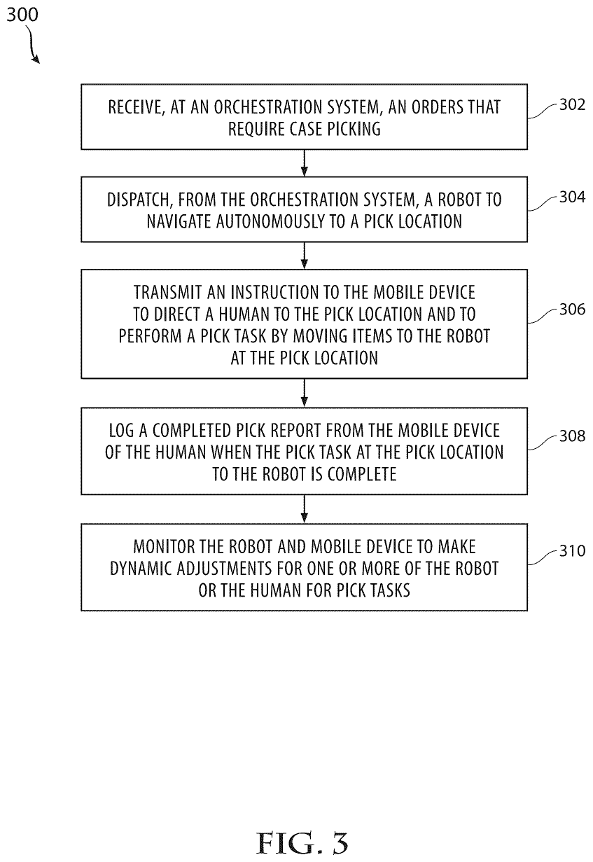

FIG. 3 illustrates a method 300 operated by the case flow system 100, which can include one or more of an orchestration system 102, a warehouse management system 103, a console system 106, a command system 108, a mobile device 110, a first robot 114 and/or a second robot 116, a computing device 500, and/or any subcomponent thereof. The first robot 114 and the second robot 116 can represent one or more robots as disclosed herein. In some aspects, the method 300 can include controlling more than two robots. Typically, the number of robots utilized in a case flow system is larger than the number of human associates.

At block 302, the system (i.e., one or more of an orchestration system 102, a warehouse management system 103, a console system 106, a command system 108, a mobile device 110, a first robot 114 and/or a second robot 116, a computing device 500, and/or any subcomponent thereof) can and is configured to: receive, at an orchestration system 102, an order that requires case picking. The order can be received from any source such as a warehouse management system 103 or from some other source. The order may be a list of specific cases or items that need to be retrieved from storage locations and placed on a mixed pallet for shipment. In some aspects, the order typically includes details such as SKUs, quantities, storage locations, and any special handling instructions. In some aspects, the order is received at a start of a shift involving operations to be performed by the human 112 and movement and actions to be performed by the robot. The warehouse management system 103 typically sends a large batch of orders in the beginning of the shift. However, the warehouse management system 103 can also send orders anytime throughout the shift. In some aspects, the concepts disclosed herein can be used to coordinate more than one human 112 and more than one robot.

At block 304, the system (i.e., one or more of an orchestration system 102, a warehouse management system 103, a console system 106, a command system 108, a mobile device 110, a first robot 114 and/or a second robot 116, a computing device 500, and/or any subcomponent thereof) can and is configured to: dispatch, from the orchestration system 102, a robot or more than one robot to navigate autonomously to a pick location 204 or to a number of different pick locations.

At block 306, the system (i.e., one or more of an orchestration system 102, a warehouse management system 103, a console system 106, a command system 108, a mobile device 110, a first robot 114 and/or a second robot 116, a computing device 500, and/or any subcomponent thereof) can and is configured to: transmit an instruction to a mobile device 110 to direct a human 112 to the pick location 204 and to perform a pick task by moving items to the robot at the pick location.

At block 308, the system (i.e., one or more of an orchestration system 102, a warehouse management system 103, a console system 106, a command system 108, a mobile device 110, a first robot 114 and/or a second robot 116, a computing device 500, and/or any subcomponent thereof) can and is configured to: log a completed pick report from the mobile device 110 of the human 112 when the pick task at the pick location to the robot is complete.

At block 310, the system (i.e., one or more of an orchestration system 102, a warehouse management system 103, a console system 106, a command system 108, a mobile device 110, a first robot 114 and/or a second robot 116, a computing device 500, and/or any subcomponent thereof) can and is configured to: monitor the robot and mobile device 110 to make dynamic adjustments for one or more of the robot or the human for pick tasks.

The system can further perform steps including: managing congestion in a warehouse in which the robot and the human; dynamically allocating pick tasks and movement of the robot to reduce idle time of the human and travel of the human; and seeking optimization opportunities for the order to be performed in the warehouse. The system may also perform a step of remotely monitoring, via a command system 108, the orchestration system 102, the robot and the mobile device 110 to keep goods flowing and to intervene if required.

In some aspects, the system can be configured to dispatch the robot to first move to an initiation area 214 to be loaded with an empty pallet and then navigate autonomously to the pick location 204.

In some aspects, when an order pallet on the robot is complete, the method 300 can include causing the robot to autonomously drop the order pallet at a staging area. In other aspects, the method 300 can further include receiving, from the human at on the mobile device, log exceptions, progress data; and managing, via the mobile device, breaks for the human.

In other aspects, the system can perform steps including one or more of: at a conclusion of the shift, receiving, on the mobile device, a logout interaction from the human and the robot returns to a home area; navigating the robot to numerous pick locations; providing, to the mobile device, guidance to go to each of the numerous pick locations for picking products to add to the robot; gathering historical data; performing analytics on the historical data to dynamically monitor performance; and/or presenting on a display real-time telemetry and performance data associated with the robot and operations of the mobile device.

The case flow system 100 can take the batch order and perform an analysis of the movements required by both humans and robots to accomplish or finalize the batch order and then map out both timelines and routes for the humans and robots to one or more pick locations through a block of time. The case flow system 100 can generate a schedule, framework or architecture for the movement for the period of time. The schedule can include a series of operations and movements for humans and robots and can include expectations of input from the mobile device 110 from the humans throughout the day. The case flow system 100 can make the schedule dynamic where it can change depending on one or more inputs or parameters throughout the day. An order may change or be cancelled, the human may take a shorter or longer time at a pick location and register with a robot that the task is done at an unexpected time. New urgent orders may come in. In some cases, the schedule can be determined based on a priority of pick assignments or items in the batch order. For example high priority boxes may need to be moved first in the morning to get to the staging area for loading into a truck by a certain time. Thus, the schedule can include priority timings for when certain sets of products need to be at a certain location for loading.

The case flow system 100 can also control or provide instructions to the vehicle 218 either to a mobile device of a driver or to the vehicle itself to also orchestrate its arrival for pickup of the set of cases 211. The timing and orchestration of the vehicle 218 might be also coordinated or chosen in view of downstream processes like trains, plains, other trucks, priority of packages, and so forth.

A system can include an orchestration system 102 including at least one processor and a computer-readable storage device that stores instructions; a robot (such as the first robot 114) in communication with the orchestration system 102; and a mobile device 110 in communication with the orchestration system 102. The instructions cause the at least one processor of the orchestration system to be configured to: receive an order that requires case picking; dispatch the robot to navigate autonomously to a pick location; transmit an instruction to the mobile device to direct a human to the pick location and to perform a pick task by moving items to the robot at the pick location; log a completed pick report from the mobile device of the human when the pick task at the pick location to the robot is complete; and continuously monitor the robot and the mobile device to make dynamic adjustments for one or more of the robot or the human for pick tasks.

The approach can be focused on or required for case picking in which boxes or heavier cases are picked or moved by humans rather than for piece picking in which smaller, lighter items are picked.

In another aspect, a system can include an orchestration system 102 including at least one processor and a computer-readable storage device that stores instructions; a robot, such as the first robot 114, in communication with the orchestration system 102; a command system 108 in communication with the orchestration system; and a mobile device 110 in communication with the orchestration system, wherein the instructions cause the at least one processor of the orchestration system to be configured to: receive an order that requires case picking; dispatch the robot to navigate autonomously to a pick location; transmit an instruction to the mobile device to direct a human to the pick location and to perform a pick task by moving items to the robot at the pick location; log a completed pick report from the mobile device of the human when the pick task at the pick location to the robot is complete; and continuously monitor, via the command system, the robot and mobile device to make dynamic adjustments for one or more of the robot or the human for pick tasks.

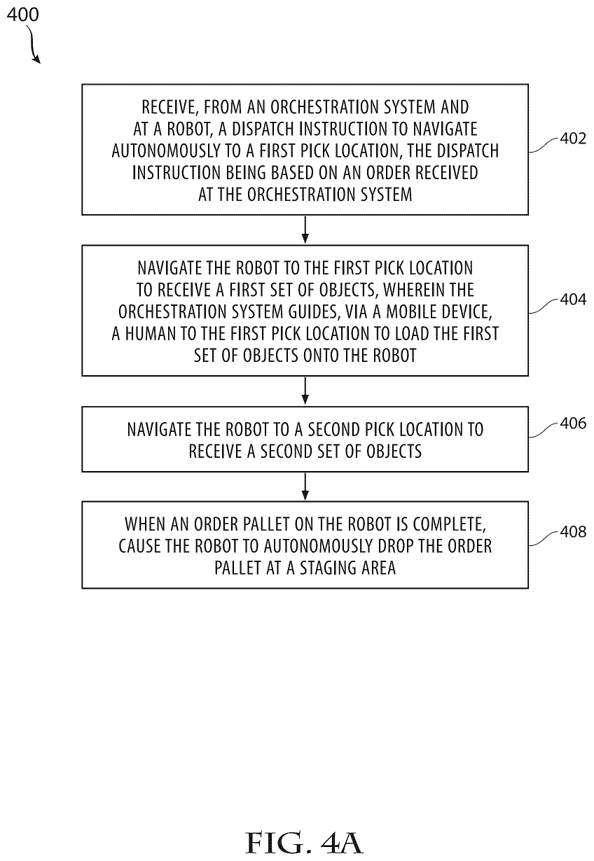

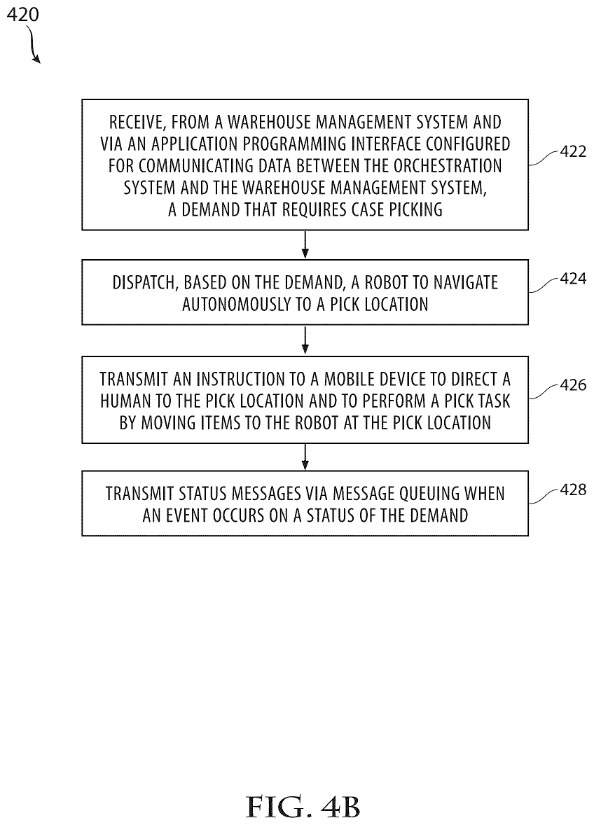

FIG. 4A illustrates another process 400 that involves the process from the standpoint of just one of the components of the case flow system 100. In this case the first robot 114 can represent a robot that can receive instructions and move as instructed to various pick locations. Any of the components disclosed herein, such as the orchestration system 102, the console system 106, the command system 108, the mobile device 110, the computing system 500, the first robot 114 and/or the second robot 116 can each be separately a separate embodiment in which just the operations of that individual component can be claimed.

At block 402, the system (i.e., one or more of an orchestration system 102, a warehouse management system 103, a console system 106, a command system 108, a mobile device 110, a first robot 114 and/or a second robot 116, a computing device 500, and/or any subcomponent thereof) can and is configured to receive, from an orchestration system and at a robot, a dispatch instruction to navigate autonomously to a first pick location, the dispatch instruction being based on a batch order received at the orchestration system.

At block 404, the system (i.e., one or more of an orchestration system 102, a warehouse management system 103, a console system 106, a command system 108, a mobile device 110, a first robot 114 and/or a second robot 116, a computing device 500, and/or any subcomponent thereof) can and is configured to navigate the robot to the first pick location to receive a first set of objects. The orchestration system 102 can guide, via a mobile device, a human to the first pick location to load the first set of objects onto the robot.

At block 406, the system (i.e., one or more of an orchestration system 102, a warehouse management system 103, a console system 106, a command system 108, a mobile device 110, a first robot 114 and/or a second robot 116, a computing device 500, and/or any subcomponent thereof) can and is configured to navigate the robot to a second pick location to receive a second set of objects.

At block 408, the system (i.e., one or more of an orchestration system 102, a warehouse management system 103, a console system 106, a command system 108, a mobile device 110, a first robot 114 and/or a second robot 116, a computing device 500, and/or any subcomponent thereof) can and is configured, when an order pallet on the robot is complete, to autonomously drop the order pallet at a staging area.

In some aspects, a robot (such as the first robot 114 or the second robot 116) is disclosed that can include at least one processor and a computer-readable storage medium storing instructions, which, when executed by the at least one processor, cause the at least one processor to be configured to: receive, from an orchestration system 102 and at the robot, a dispatch instruction to navigate autonomously to a first pick location, the dispatch instruction being based on a batch order received at the orchestration system 102; navigate the robot to the first pick location to receive a first set of objects, wherein the orchestration system 102 guides, via a mobile device, a human to the first pick location to load the first set of objects onto the robot; navigate the robot to a second pick location to receive a second set of objects; and, when an order pallet on the robot is complete, autonomously drop the order pallet at a staging area such as the staging area 216 so that a vehicle 218 can haul the order to a final destination.

FIG. 4B illustrates another process 420 that involves the process from the standpoint of just one of the components of the case flow system 100. In this case the first robot 114 can represent a robot that can receive instructions and move as instructed to various pick locations. Any of the components disclosed herein, such as the orchestration system 102, the console system 106, the command system 108, the mobile device 110, a computing system 500, the first robot 114 and/or the second robot 116 can each be separately a separate embodiment in which just the operations of that individual component can be claimed. The process 420 generally relates to the discussion associated with FIG. 1B and the orchestration system 102 interacting with both the warehouse management system 103 that provides orders or demands to the orchestration system 102 via an API for implementation in the warehouse according to the intelligence built into the orchestration system 102 for managing humans and robots for picking operations that are safe and efficient.

At block 422, the system (i.e., one or more of an orchestration system 102, a warehouse management system 103, a console system 106, a command system 108, a mobile device 110, a first robot 114 and/or a second robot 116, a computing device 500, and/or any subcomponent thereof) can and is configured to receive, from a warehouse management system and via an application programming interface configured for communicating data between the orchestration system 102 and the warehouse management system 103, a demand that requires case picking. The demand may be received at a start of a shift involving operations to be performed by the human and movement and actions to be performed by the robot.

At block 424, the system (i.e., one or more of an orchestration system 102, a warehouse management system 103, a console system 106, a command system 108, a mobile device 110, a first robot 114 and/or a second robot 116, a computing device 500, and/or any subcomponent thereof) can and is configured to dispatch, based on the demand, a robot to navigate autonomously to a pick location.

At block 426, the system (i.e., one or more of an orchestration system 102, a warehouse management system 103, a console system 106, a command system 108, a mobile device 110, a first robot 114 and/or a second robot 116, a computing device 500, and/or any subcomponent thereof) can and is configured to transmit an instruction to a mobile device to direct a human to the pick location and to perform a pick task by moving items to the robot at the pick location.

At block 428, the system (i.e., one or more of an orchestration system 102, a warehouse management system 103, a console system 106, a command system 108, a mobile device 110, a first robot 114 and/or a second robot 116, a computing device 500, and/or any subcomponent thereof) can and is configured to transmit status messages via message queuing when an event occurs on a status of the demand.

In some aspects, the process 420 can include the system being configured to transmit pick exceptions (e.g., insufficient quantity, pallet full) to a warehouse management system or other system. The system can be configured to receive instructions on how to handle the exception. For example, the system or robot may retry a pick at the end of a pick tour or may take some other action based on a pick exception that is identified.

In some aspects, the event can comprise one or more of a demand created, a demand rejected, an update applied, an update partially applied, an update rejected, a pick-list started, a pick done, a drop-off complete, a cancellation complete, a cancellation rejected, a demand failed and an unexpected error.

In some aspects, the dispatching, from the orchestration system and based on the demand, of the robot to navigate autonomously to a pick location is performed based on a priority level set by the warehouse management system for the demand. In some aspects, transmitting an instruction to the mobile device to direct the human to the pick location and to perform the pick task by moving items to the robot at the pick location can be performed based on a work distribution amongst humans according to one or more human factors. The one or more human factors can include, for example, worker fatigue, distance to travel, weight to be lifted, weight previously lifted in a shift, completed tasks, shift time, worker time on a respective shift, worker characteristics, and worker priority.

In other aspects, dispatching, from the orchestration system and based on the demand, the robot to navigate autonomously to a pick location can be performed based on one or more of congestion avoidance, a capacity check, a priority evaluation, a value associated with idle zone monitoring, a dynamic demand profile, and a value associated with reducing bottlenecks. In another aspect, transmitting an instruction to the mobile device to direct the human to the pick location and to perform the pick task by moving items to the robot at the pick location can be performed based on one or more of an evaluation of idle time of humans, a human travel distance, whether a human can choose an available robot to pick to, and a value related to a distribution of work based on worker fatigue levels and completed tasks.

In some aspects, the dispatching, from the orchestration system and based on the demand, of the robot to navigate autonomously to the pick location and transmitting the instruction to the mobile device to direct the human to the pick location and to perform the pick task by moving items to the robot at the pick location can be performed based on a group of demands received such that demands are prioritized and assigned based on priority and according to dynamic monitoring for congestion for current and future activities. Further, the dispatching, from the orchestration system and based on the demand, of the robot to navigate autonomously to the pick location and transmitting the instruction to the mobile device to direct the human to the pick location and to perform the pick task by moving items to the robot at the pick location can be performed based on one or more of a live floor map, live metric data, human performance metrics, historical analytics, detailed daily reporting data, a demand profile analysis, a cycle time analysis and a heatmap analysis.

The process 420 can include additional optional steps as well. For example, the process 420 can include monitoring the robot and mobile device to make dynamic adjustments for one or more of the robot or the human for pick tasks. The process 420 can include managing congestion in a warehouse in which the robot and the human both operate; dynamically allocating pick tasks and movement of the robot to reduce idle time of the human and travel of the human; and seeking optimization opportunities for the demand to be performed in the warehouse.

The process 420 may include remotely monitoring, via a command system, the orchestration system, the robot and the mobile device to keep goods flowing and to intervene if required or dispatching the robot to first move to an initiation area to be loaded with an empty pallet and then navigate autonomously to the pick location.

In some aspects, the process 420 can include, when an order pallet on the robot is complete according to the demand, causing the robot to autonomously drop the order pallet at a staging area.

In other aspects, the process 420 can include receiving, from the human at on the mobile device, log exceptions, progress data; and managing, via the mobile device, breaks for the human or, at a conclusion of the shift, receiving, on the mobile device, a logout interaction from the human and the robot returns to a home area.

The process 420 can include navigating the robot to numerous pick locations and providing, to the mobile device, guidance to go to each of the numerous pick locations for picking products to add to the robot.

The process 420 might include gathering historical data, performing analytics on the historical data to dynamically monitor performance and presenting on a display real-time telemetry and performance data associated with the robot and operations of the mobile device.

In some aspects, an orchestration system can include at least one processor; and a computer-readable storage device that stores instructions which, when executed by the at least one processor, cause the at least one processor to be configured to: receive, from a warehouse management system and via an application programming interface configured for communicating data between the orchestration system and the warehouse management system, a demand that requires case picking; dispatch, based on the demand, a robot to navigate autonomously to a pick location; transmit an instruction to a mobile device to direct a human to the pick location and to perform a pick task by moving items to the robot at the pick location; and transmit status messages via message queuing when an event occurs on a status of the demand.

Any of the processes, systems or methods disclosed herein can include a disclosed element that can be combined with other elements from other processes, systems or methods. Note as well that while the processes are typically described with respect to the orchestration system 102 and the operations performed by that system, that the disclosure covers any complementary processes and systems as well. For example, if a method covers the orchestration system 102 transmitting an instruction to a robot, or transmitting an instruction to a mobile device to direct a human to a pick location, then this disclosure also covers the robot receiving the instruction and performing the instructed tasks including moving to a pick location. The mobile device can be claimed for receiving the instruction and providing on a user interface information for the human to guide the human to a pick location and to enable interactions between the human and the mobile device as well as communications visually or via a wireless communication protocol with the robot for reporting, event status information, task completion, further instructions and so forth.

The various example systems that can be claimed include each system disclosed herein such as the warehouse management system 103, the orchestration system 102, the mobile device 110, the command system 108, a first robot 114, a second robot 116, and so forth.

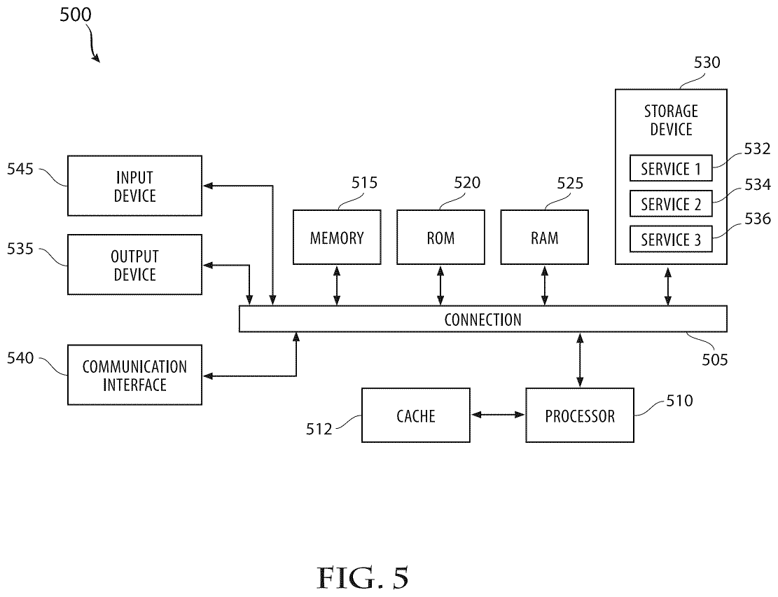

FIG. 5 illustrates example computer device that can be used in connection with any of the systems disclosed herein. For example, items in the computing device can be part of the control mechanism 118 shown above. In this example, FIG. 5 illustrates a computing system 500 including components in electrical communication with each other using a connection 505, such as a bus. System 500 includes a processing unit (CPU or processor) 510 and a system connection 505 that couples various system components including the system memory 515, such as read only memory (ROM) 520 and random access memory (RAM) 525, to the processor 510. The system 500 can include a cache of high-speed memory connected directly with, in close proximity to, or integrated as part of the processor 510. The system 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other system memory 515 may be available for use as well. The memory 515 can include multiple different types of memory with different performance characteristics. The processor 510 can include any general-purpose processor and a hardware or software service, such as service 1 532, service 2 534, and service 3 536 stored in storage device 530, configured to control the processor 510 as well as a special-purpose processor where software instructions are incorporated into the actual processor design. The processor 510 may be a completely self-contained computing system, containing multiple cores or processors, a bus, memory controller, cache, etc. A multi-core processor may be symmetric or asymmetric.

To enable user interaction with the device 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art. In some instances, multimodal systems can enable a user to provide multiple types of input to communicate with the device 500. The communications interface 540 can generally govern and manage the user input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include services 532, 534, 536 for controlling the processor 510. Other hardware or software modules are contemplated. The storage device 530 can be connected to the system connection 505. In one aspect, a hardware module that performs a particular function can include the software component stored in a computer-readable medium in connection with the necessary hardware components, such as the processor 510, connection 505, output device 535, and so forth, to carry out the function.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

### Clause Set I:

Clause 1. A system comprising: an orchestration system comprising at least one processor and a computer-readable storage device that stores instructions; a robot in communication with the orchestration system; and a mobile device in communication with the orchestration system, wherein the instructions cause the at least one processor of the orchestration system to be configured to: receive an order that requires case picking; dispatch the robot to navigate autonomously to a pick location; transmit an instruction to the mobile device to direct a human to the pick location and to perform a pick task by moving items to the robot at the pick location; log a completed pick report from the mobile device of the human when the pick task at the pick location to the robot is complete; and continuously monitor the robot and the mobile device to make dynamic adjustments for one or more of the robot or the human for pick tasks.

Clause 2. The system of clause 1, wherein the instructions cause the computer-readable storage device to cause the at least one processor to be configured to: manage congestion; dynamically allocate pick tasks and movement of the robot to reduce idle time of the human and travel of the human; and seek optimization opportunities.

Clause 3. The system of clause 1 or any previous claim, further comprising: a command system in communication with the orchestration system, the command system configured to remotely monitor the orchestration system, the robot and the mobile device to keep goods flowing and to intervene if required.

Clause 4. The system of clause 1 or any previous claim, wherein the instructions cause the computer-readable storage device to cause the at least one processor to be configured to: dispatch the robot to first move to an initiation area to be loaded with an empty pallet and then navigate autonomously to the pick location.

Clause 5. The system of clause 1 or any previous claim, wherein the instructions cause the computer-readable storage device of the orchestration system to cause the at least one processor to be configured to: when an order pallet on the robot is complete, cause the robot to autonomously drop the order pallet at a staging area.

Clause 6. The system of clause 1 or any previous claim, the mobile device is configured to: receive, from the human, log exceptions, track progress and manage breaks for the human.

Clause 7. The system of clause 1 or any previous claim, wherein the order is received at a start of a shift involving operations to be performed by the human and movement and actions to be performed by the robot.

Clause 8. The system of clause 7 or any previous claim, wherein at a conclusion of the shift, the mobile device is configured to receive a logout interaction from the human and the robot returns to a home area.

Clause 9. The system of clause 1 or any previous claim, wherein the robot is configured to move to numerous pick locations and the mobile device guides the human to each of the numerous pick locations for picking products to add to the robot.

Clause 10. The system of clause 1 or any previous claim, wherein the instructions cause the computer-readable storage device of the orchestration system to cause the at least one processor to be configured to: gather historical data; perform analytics on the historical data to dynamically monitor performance; and present on a display real-time telemetry and performance data associated with the robot and operations of the mobile device.

Clause 11. A method comprising: receiving, at an orchestration system, an order that requires case picking; dispatching, from the orchestration system, a robot to navigate autonomously to a pick location; transmitting an instruction to a mobile device to direct a human to the pick location and to perform a pick task by moving items to the robot at the pick location; logging a completed pick report from the mobile device of the human when the pick task at the pick location to the robot is complete; and monitoring the robot and mobile device to make dynamic adjustments for one or more of the robot or the human for pick tasks.

Clause 12. The method of clause 11, further comprising: managing congestion in a warehouse in which the robot and the human both operate; dynamically allocating pick tasks and movement of the robot to reduce idle time of the human and travel of the human; and seeking optimization opportunities for the order to be performed in the warehouse.

Clause 13. The method of clause 11 or any previous claim, further comprising: remotely monitoring, via a command system, the orchestration system, the robot and the mobile device to keep goods flowing and to intervene if required.

Clause 14. The method of clause 11 or any previous claim, further comprising: dispatching the robot to first move to an initiation area to be loaded with an empty pallet and then navigate autonomously to the pick location.

Clause 15. The method of clause 11 or any previous claim, further comprising: when an order pallet on the robot is complete, causing the robot to autonomously drop the order pallet at a staging area.

Clause 16. The method of clause 11 or any previous claim, further comprising: receiving, from the human at on the mobile device, log exceptions, progress data; and managing, via the mobile device, breaks for the human.

Clause 17. The method of clause 11 or any previous claim, wherein the order is received at a start of a shift involving operations to be performed by the human and movement and actions to be performed by the robot.

Clause 18. The method of clause 17 or any previous claim, further comprising: at a conclusion of the shift, receiving, on the mobile device, a logout interaction from the human and the robot returns to a home area.

Clause 19. The method of clause 11 or any previous claim, further comprising: navigating the robot to numerous pick locations; and providing, to the mobile device, guidance to go to each of the numerous pick locations for picking products to add to the robot.

Clause 20. The method of clause 11 or any previous claim, further comprising: gathering historical data; performing analytics on the historical data to dynamically monitor performance; and presenting on a display real-time telemetry and performance data associated with the robot and operations of the mobile device.

Clause 21. A system comprising: an orchestration system comprising at least one processor and a computer-readable storage device that stores instructions; a robot in communication with the orchestration system; a command system in communication with the orchestration system; and a mobile device in communication with the orchestration system, wherein the instructions cause the at least one processor of the orchestration system to be configured to: receive an order that requires case picking; dispatch the robot to navigate autonomously to a pick location; transmit an instruction to the mobile device to direct a human to the pick location and to perform a pick task by moving items to the robot at the pick location; log a completed pick report from the mobile device of the human when the pick task at the pick location to the robot is complete; and continuously monitor, via the command system, the robot and mobile device to make dynamic adjustments for one or more of the robot or the human for pick tasks.

Clause 22. A method comprising: receiving, from an orchestration system and at a robot, a dispatch instruction to navigate autonomously to a first pick location, the dispatch instruction being based on a batch order received at the orchestration system; navigating the robot to the first pick location to receive a first set of objects, wherein the orchestration system guides, via a mobile device, a human to the first pick location to load the first set of objects onto the robot; navigating the robot to a second pick location to receive a second set of objects; and when an order pallet on the robot is complete, causing the robot to autonomously drop the order pallet at a staging area.

Clause 23. A robot comprising at least one processor and a computer-readable storage medium storing instructions, which, when executed by the at least one processor, cause the at least one processor to be configured to: receive, from an orchestration system and at a robot, a dispatch instruction to navigate autonomously to a first pick location, the dispatch instruction being based on a batch order received at the orchestration system; navigate the robot to the first pick location to receive a first set of objects, wherein the orchestration system guides, via a mobile device, a human to the first pick location to load the first set of objects onto the robot; navigate the robot to a second pick location to receive a second set of objects; and when an order pallet on the robot is complete, autonomously drop the order pallet at a staging area.

### Clause Set II:

Clause 1. A method comprising: receiving, from a warehouse management system, at an orchestration system and via an application programming interface configured for communicating data between the orchestration system and the warehouse management system, a demand that requires case picking; dispatching, from the orchestration system and based on the demand, a robot to navigate autonomously to a pick location; transmitting an instruction to a mobile device to direct a human to the pick location and to perform a pick task by moving items to the robot at the pick location; and transmitting status messages via message queuing when an event occurs on a status of the demand.

Clause 2. The method of clause 1, further comprising: monitoring the robot and mobile device to make dynamic adjustments for one or more of the robot or the human for pick tasks.

Clause 3. The method of clause 1 or any previous clause, further comprising: managing congestion in a warehouse in which the robot and the human both operate; dynamically allocating pick tasks and movement of the robot to reduce idle time of the human and travel of the human; and seeking optimization opportunities for the demand to be performed in the warehouse.

Clause 4. The method of clause 1 or any previous clause, further comprising: remotely monitoring, via a command system, the orchestration system, the robot and the mobile device to keep goods flowing and to intervene if required.

Clause 5. The method of clause 1 or any previous clause, further comprising: dispatching the robot to first move to an initiation area to be loaded with an empty pallet and then navigate autonomously to the pick location.

Clause 6. The method of clause 1 or any previous clause, further comprising: when an order pallet on the robot is complete according to the demand, causing the robot to autonomously drop the order pallet at a staging area.

Clause 7. The method of clause 1 or any previous clause, further comprising: receiving, from the human at on the mobile device, log exceptions, progress data; and managing, via the mobile device, breaks for the human.

Clause 8. The method of clause 1 or any previous clause, wherein the demand is received at a start of a shift involving operations to be performed by the human and movement and actions to be performed by the robot.

Clause 9. The method of clause 8 or any previous clause, further comprising: at a conclusion of the shift, receiving, on the mobile device, a logout interaction from the human and the robot returns to a home area.

Clause 10. The method of clause 1 or any previous clause, further comprising: navigating the robot to numerous pick locations; and providing, to the mobile device, guidance to go to each of the numerous pick locations for picking products to add to the robot.

Clause 11. The method of clause 1 or any previous clause, further comprising: gathering historical data; performing analytics on the historical data to dynamically monitor performance; and presenting on a display real-time telemetry and performance data associated with the robot and operations of the mobile device.

Clause 12. The method of clause 1 or any previous clause, wherein the event can comprise one or more of a demand created, a demand rejected, an update applied, an update partially applied, an update rejected, a pick-list started, a pick done, a drop-off complete, a cancellation complete, a cancellation rejected, a demand failed and an unexpected error.

Clause 13. The method of clause 1 or any previous clause, wherein dispatching, from the orchestration system and based on the demand, the robot to navigate autonomously to a pick location is performed based on a priority level set by the warehouse management system for the demand.

Clause 14. The method of clause 13 or any previous clause, wherein transmitting an instruction to the mobile device to direct the human to the pick location and to perform the pick task by moving items to the robot at the pick location is performed based on a work distribution amongst humans according to one or more human factors.

Clause 15. The method of clause 14 or any previous clause, wherein the one or more human factors comprise worker fatigue, distance to travel, weight to be lifted, weight previously lifted in a shift, completed tasks, shift time, worker time on a respective shift, worker characteristics, and worker priority.

Clause 16. The method of clause 1 or any previous clause, wherein dispatching, from the orchestration system and based on the demand, the robot to navigate autonomously to a pick location is performed based on one or more of congestion avoidance, a capacity check, a priority evaluation, a value associated with idle zone monitoring, a dynamic demand profile, and a value associated with reducing bottlenecks.

Clause 17. The method of clause 1 or any previous clause, wherein transmitting an instruction to the mobile device to direct the human to the pick location and to perform the pick task by moving items to the robot at the pick location is performed based on one or more of an evaluation of idle time of humans, a human travel distance, whether a human can choose an available robot to pick to, and a value related to a distribution of work based on worker fatigue levels and completed tasks.

Clause 18. The method of clause 1 or any previous clause, wherein dispatching, from the orchestration system and based on the demand, the robot to navigate autonomously to the pick location and transmitting the instruction to the mobile device to direct the human to the pick location and to perform the pick task by moving items to the robot at the pick location are performed based on a group of demands received such that demands are prioritized and assigned based on priority and according to dynamic monitoring for congestion for current and future activities.

Clause 19. The method of clause 1 or any previous clause, wherein dispatching, from the orchestration system and based on the demand, the robot to navigate autonomously to the pick location and transmitting the instruction to the mobile device to direct the human to the pick location and to perform the pick task by moving items to the robot at the pick location are performed based on one or more of a live floor map, live metric data, human performance metrics, historical analytics, detailed daily reporting data, a demand profile analysis, a cycle time analysis and a heatmap analysis.

Clause 20. An orchestration system comprising: at least one processor; and a computer-readable storage device that stores instructions which, when executed by the at least one processor, cause the at least one processor to be configured to: receive, from a warehouse management system and via an application programming interface configured for communicating data between the orchestration system and the warehouse management system, a demand that requires case picking; dispatch, based on the demand, a robot to navigate autonomously to a pick location; transmit an instruction to a mobile device to direct a human to the pick location and to perform a pick task by moving items to the robot at the pick location; and transmit status messages via message queuing when an event occurs on a status of the demand.

Clause 21. A method comprising: receiving, from a warehouse management system, at an orchestration system and via an application programming interface configured for communicating data between the orchestration system and the warehouse management system, a demand that requires case picking; dispatching, from the orchestration system and based on the demand, a robot to navigate autonomously to a pick location; transmitting an instruction to a mobile device to direct a human to the pick location and to perform a pick task by moving items to the robot at the pick location; transmitting a pick exception message when an exception event occurs; receiving instructions on how to handle the pick exception; and carrying out an action based on the instructions in order to handle the pick exception.

Clause 22. The method of clause 21, wherein the action comprises retrying a pick based on the instructions.

What is claimed is:

1. A system comprising:
an orchestration system comprising at least one processor and a computer-readable storage device that stores instructions;
a robot in communication with the orchestration system; and
a mobile device in communication with the orchestration system, wherein the instructions cause the at least one processor of the orchestration system to be configured to:
receive an order that requires case picking;
dispatch the robot to navigate autonomously to a pick location;
transmit an instruction to the mobile device to direct a human to the pick location and to perform a pick task by moving items to the robot at the pick location;
log a completed pick report from the mobile device of the human when the pick task at the pick location to the robot is complete; and
continuously monitor the robot and the mobile device to make dynamic adjustments for one or more of the robot or the human for pick tasks.

2. The system of claim 1, wherein the instructions cause the computer-readable storage device to cause the at least one processor to be configured to: manage congestion; dynamically allocate pick tasks and movement of the robot to reduce idle time of the human and travel of the human; and seek optimization opportunities.

3. The system of claim 1, further comprising:
a command system in communication with the orchestration system, the command system configured to remotely monitor the orchestration system, the robot and the mobile device to keep goods flowing and to intervene if required.

4. The system of claim 1, wherein the instructions cause the computer-readable storage device to cause the at least one processor to be configured to: dispatch the robot to first move to an initiation area to be loaded with an empty pallet and then navigate autonomously to the pick location.

5. The system of claim 1, wherein the instructions cause the computer-readable storage device of the orchestration system to cause the at least one processor to be configured to:
when an order pallet on the robot is complete, cause the robot to autonomously drop the order pallet at a staging area.

6. The system of claim 1, the mobile device is configured to: receive, from the human, log exceptions, track progress and manage breaks for the human.

7. The system of claim 1, wherein the order is received at a start of a shift involving operations to be performed by the human and movement and actions to be performed by the robot.

8. The system of claim 7, wherein at a conclusion of the shift, the mobile device is configured to receive a logout interaction from the human and the robot returns to a home area.

9. The system of claim 1, wherein the robot is configured to move to numerous pick locations and the mobile device guides the human to each of the numerous pick locations for picking products to add to the robot.

10. The system of claim 1, wherein the instructions cause the computer-readable storage device of the orchestration system to cause the at least one processor to be configured to:
gather historical data;
perform analytics on the historical data to dynamically monitor performance; and
present on a display real-time telemetry and performance data associated with the robot and operations of the mobile device.

11. A method comprising:
receiving, at an orchestration system, an order that requires case picking;
dispatching, from the orchestration system, a robot to navigate autonomously to a pick location;
transmitting an instruction to a mobile device to direct a human to the pick location and to perform a pick task by moving items to the robot at the pick location;
logging a completed pick report from the mobile device of the human when the pick task at the pick location to the robot is complete; and
monitoring the robot and mobile device to make dynamic adjustments for one or more of the robot or the human for pick tasks.

12. The method of claim 11, further comprising:
managing congestion in a warehouse in which the robot and the human both operate;
dynamically allocating pick tasks and movement of the robot to reduce idle time of the human and travel of the human; and
seeking optimization opportunities for the order to be performed in the warehouse.

13. The method of claim 11, further comprising:
remotely monitoring, via a command system, the orchestration system, the robot and the mobile device to keep goods flowing and to intervene if required.

14. The method of claim 11, further comprising:
dispatching the robot to first move to an initiation area to be loaded with an empty pallet and then navigate autonomously to the pick location.

15. The method of claim 11, further comprising:
when an order pallet on the robot is complete, causing the robot to autonomously drop the order pallet at a staging area.

16. The method of claim 11, further comprising:
receiving, from the human at on the mobile device, log exceptions, progress data; and
managing, via the mobile device, breaks for the human.

17. The method of claim 11, wherein the order is received at a start of a shift involving operations to be performed by the human and movement and actions to be performed by the robot.

18. The method of claim 17, further comprising:
at a conclusion of the shift, receiving, on the mobile device, a logout interaction from the human and the robot returns to a home area.

19. The method of claim 11, further comprising:
navigating the robot to numerous pick locations; and
providing, to the mobile device, guidance to go to each of the numerous pick locations for picking products to add to the robot.

20. The method of claim 11, further comprising:
gathering historical data;
performing analytics on the historical data to dynamically monitor performance; and
presenting on a display real-time telemetry and performance data associated with the robot and operations of the mobile device.

21. A system comprising:
an orchestration system comprising at least one processor and a computer-readable storage device that stores instructions;
a robot in communication with the orchestration system;
a command system in communication with the orchestration system; and
a mobile device in communication with the orchestration system, wherein the instructions cause the at least one processor of the orchestration system to be configured to:
receive an order that requires case picking;
dispatch the robot to navigate autonomously to a pick location;
transmit an instruction to the mobile device to direct a human to the pick location and to perform a pick task by moving items to the robot at the pick location;
log a completed pick report from the mobile device of the human when the pick task at the pick location to the robot is complete; and
continuously monitor, via the command system, the robot and mobile device to make dynamic adjustments for one or more of the robot or the human for pick tasks.
